(19) United States
(12) Patent Application Publication
(10) Pub. No.: US 2008/0198703 A1
(43) Pub. Date: Aug. 21, 2008

(54) Children's time signal

(76) Inventor: Marlys Dickmeyer, Zimmerman, MN (US)

Correspondence Address: Gary L. Huusko, Suite 600, 7300 West 147th Street, Apple Valley, MN, 55124, US

(21) Appl. No.: 11/706,523

(22) Filed: Feb. 15, 2007

(51) Int. Cl. G04C 19/02

(52) U.S. Cl. 368/250

(57) ABSTRACT

A children's time signal device whereby a parent can set a predetermined time of day or period of time at which a decorative feature of the face plate would illuminate, such as a clown's nose on a clown face plate, to be used to teach and inform a child or toddler when to start or stop an activity, when to get up from a nap, as a meal-time signal informing the toddler when meal time occurs, or as a discipline timer, informing the toddler when the time-out discipline ends.

### BACKGROUND OF INVENTION

1. Field of invention

The present invention relates to a children's timing device, more particularly, an informational and child-friendly signal device to inform and teach young children when it is okay to wake up and get out of bed, when to start or stop an activity, and other activities that are capable of being timed.

2. Discussion of Prior Art

There are many clock timers available in the arts that can be set to sound an alarm or turn on a radio for waking people, and even to indicate whether it is daylight or nighttime. The McGinnis-Smith, et al., U.S. Pat. No. 6,392,963 describes a children's timer device that indicates waking time and sleeping time by means of a rotating cylinder upon which two images are shown and viewed through a display such that one image is viewable during the daylight hours and the other image is viewable during the nighttime hours, the daylight image showing a scene understood by the child viewer to be a waking activity so the child can wake up, and the nighttime image showing a scene understood by the child viewer to be a sleeping activity so the child remains in bed. The Claessens, U.S. Pat. Publ. No. 20050117458, describes a similar child's timer device with an interchangeable face showing a waking design and a sleeping design, the waking design being activated when the timer is set for waking the child, and the sleeping design being activated when the child should be asleep.

The disadvantages inherent in the prior art include moving faceplates and, in the case of the Claessens child's clock indicator, a light that remains on, merely switching between a waking design and a sleeping design. The present invention overcomes those disadvantages with fewer moving parts making the invention quiet, and a sleeping function that remains dark, thus not interfering with the child's sleep due to unnatural noise or light.

A further disadvantage of the prior art devices is that most are illuminated all of the time, changing only the scene that is illuminated, or illuminating a different part of the face plate of the prior art clock. Some studies have shown that nightlights or unnatural lighting can disrupt or affect sleep patterns of young children. The present invention is not always illuminated, thus overcoming those concerns.

### DESCRIPTION OF THE MAIN EMBODIMENT

The present invention is a children's time signal to assist toddlers in making decisions when to stay in bed and sleep, or when to begin or end an activity. The time signal comprises a housing unit with a face plate opening, a face plate with a decorative signal generator, such as a clock timer means with clock timer setting means, a controller, one or more illuminating sources and one or more power sources, such that a parent can set the clock timer to a certain time of day or night sending a signal to the controller which would activate the illuminating means, such as an LED, low wattage bulb or other light or illumination generation source or one or more colors, shapes or designs, that will then signal the toddler that it is okay for them to get out of bed or to begin or end an activity. The face plate of the children's time signal can be any color, shape, design or child-friendly figure, such as a clown face or a fanciful children's scene, such as a princess with a wand or a meadow with a bird in the sky. The face plate scenes are limitless requiring only an identifiable object, preferably decorative or easily identifiable by the child, that can be illuminated, such as a clown's nose, a bird in the sky or the tip of a wand.

The controller would contain imbedded logic which receives and deciphers one or more analog or digital signals from one or more signal generators. The controller turns on or off the power to the illuminating means based upon the signals received from the signal generator. The controller could cause the illuminating means to either turn on and remain on for a specified period of time and then turn off or remain on until the signal generator or clock timer means is reset.

The signal generator would include one or more internal or external analog or digital timer using existing technology, such as that used in stopwatches, which will generate one or more signals based upon manual or electronic inputs to the signal generator by the parent. The signal may be arranged in one or more patterns selected by the parent such that the timer will cause a signal to be sent to the controller which will cause one or more light sources to emit light in one or more colors and in one or more patterns after the passing of a amount of time specified by the parent by means of pressing one or more buttons on the timer. The internal or external analog or digital timer could also cause a signal to be sent to the controller at a time of day specified by the parent by means of pressing one or more buttons on the time signal device. Another embodiment would show external signal generators from computers, security or other systems transmitted to the controller by various methods, including but not limited to wired and wireless connections to the Internet.

The power sources can be any of the following, an AC electrical input from an external AC electrical source such as a wall socket which will be connected to a converter to convert the AC power into DC power, a DC power from an internal battery or from an outside source through a DC connector such as car cigarette lighter, or an internal solar power generator producing DC electrical current. The power source then is connected to the signal generator, the controller and the light source to provide each with power.

In operation, a parent would set the time on the time signal generator, using the clock timer means, for when the toddler could get out of bed or begin or end an activity. The clock timer means could be set for a certain time of day or for a certain number of hours or minutes, or a combination of hours and minutes. The clock timer means would then send a signal to the controller at the appointed time to activate the illuminating means at the preset time or time period, illuminating one or more decorative identifiable objects such as a clown's nose on the face plate. The clock face would remain non-illuminated until the appointed time, thus keeping the toddler's room dark. The decorative identifiable object would be translucent such that light from the illuminating means can be seen through and illuminates the decorative identifiable object of the face plate.

When the toddler would view the time signal device and see the clown's nose illuminated, the toddler would know that he or she could get out of bed, or begin or end an activity, as the case may be. The illumining light could be gentle and soft, so that it would wake the toddler if the toddler were still asleep or it could be bright so it can be viewed in illuminated rooms. This feature allows the time signal device to be used as a learning tool for the toddler teaching the toddler when he or she would be allowed to get out of bed or begin or end an activity, rather than as simply an alarm to wake the toddler or notify the child or when the activity could begin or end. Likewise, if the decorative identifiable object, such as a clown's nose was not illuminated, the toddler would know that he or she should remain in bed, or continue the activity, as the case may be.

The many benefits and advantages of the present invention include teaching the toddler when he or she could get our of bed or call out for their parents to assist them in getting out of bed; parents can achieve more uninterrupted sleep; there is less likelihood of conflict between parents and toddlers since the toddlers would learn and know when they can act on certain time events, and the child or toddler learns more responsibility and gains confidence in learning and knowing what he or she can or cannot do when the time signal illuminates.

### SUMMARY OF THE INVENTION

The present invention is a child's time signal with a housing unit made out of a child-safe, unbreakable material, such as lightweight, shatterproof plastic, a face plate opening in the housing unit, and comprising a signal generator timing means, such as a clock timer, and a time setting means to set the timing means, a controller, an illuminating means, such as a low watt light bulb or LED, a power source, which could be either DC or AC, or a combination of both utilizing the battery source as a back-up power source in the event of electrical power failure, a decorative and informative face plate over the face plate opening of the housing unit, such as a clown's face, and a circuit means to connect the power source to the signal generator means, the controller and illuminating means, where the time signal would be placed in a child's room or elsewhere, the parent setting a certain time of day or a certain time period using the signal generator timing means, in hours or minutes or a combination of hours and minutes, and at the preset time or at the end of the preset number of hours, minutes or combination thereof, the timing means signal the controller which would activate the illuminating means, thereby lighting the decorative identifiable object, such as a clown's nose, whereby the child or toddler would then know he or she could get out of bed or end the activity, as the case may be.

The time signal could also be used to inform the toddler when to start and stop an activity, when to get up from a nap, as a meal-time signal informing the toddler when meal time occurs, or as a discipline timer, informing the toddler when the time-out discipline ends.

### BRIEF DESCRIPTION OF DRAWINGS

FIG. 1 is a front view of the time signal.

FIG. 2 is a back view of the time signal.

FIG. 3 is a schematic of the operation of the time signal device showing the various and alternate components.

### DETAILED DESCRIPTION OF THE DRAWINGS

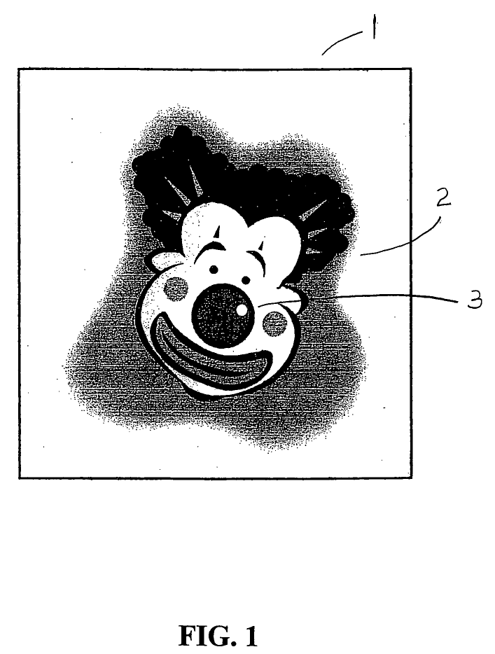

Referring to FIG. 1, a time signal 1 is shown with a clown's face faceplate 2 and a clown's nose 3. The clown's nose 3 would be of sufficient size to allow adequate noticeability of the clown's nose when it illuminates. Other fanciful or decorative faceplates can be used as well, so long as there is a decorative identifiable object feature that can be illuminated and noticed easily by the toddler. Multi-colored lights and flashing lights can also be used.

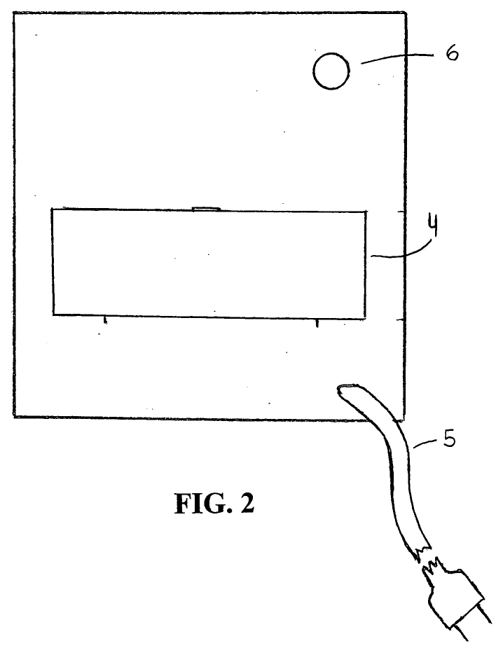

FIG. 2 shows a back view of the time signal. A battery compartment 4 is shown, as is an AC power cord 5 for plugging the device into a wall outlet for power. The time signal can utilize both battery power or AC power, or a combination of both, or can be run from an automobile lighter plug-in.

Still referring to FIG. 2, a time signal generator means 6 is shown, although the time signal generator means 6 can be placed wherever it may be convenient, such as on the side or front of the time signal as well.

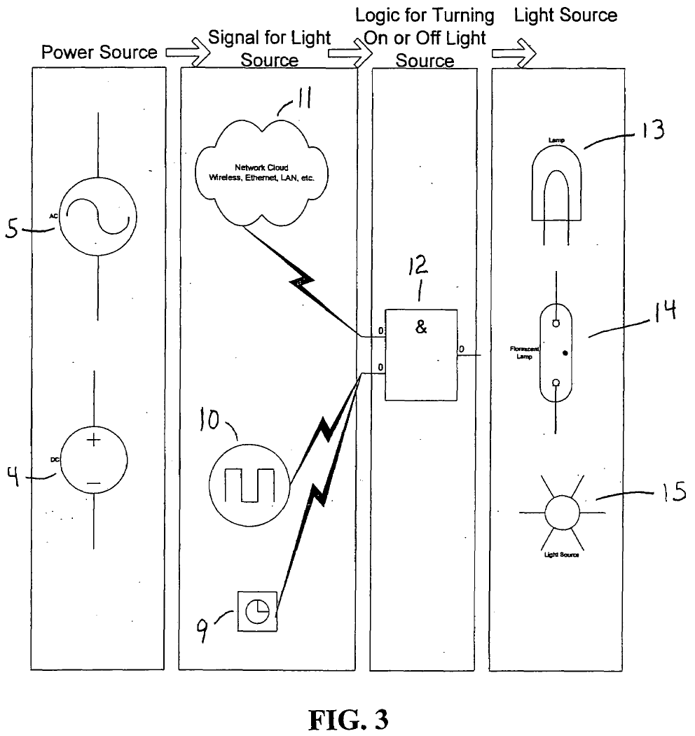

Referring to FIG. 3, a schematic diagram is shown of the time signal device showing an AC power source 5, and a DC power source 4, a clock timer means 9, an electronic timer means 10, and a wireless signal timer means 11. The power sources 4, 5 connect electronically to the time signal generator means 6, which is connected to the controller 12 either electronically or wirelessly, the controller 12 then signals the illuminating means, shown in FIG. 3 as a filament lamp 13, a fluorescent lamp 14, or another light source 15, such as an LED.

In operation, a parent would program the time signal generator means 6 to a preset time or period of time at which the controller 12 would send a signal to the illuminating means, such as a filament lamp 13, a fluorescent lamp 14, or another light source 15, such as an LED, illuminating the clown's nose 3 or other decorative identifiable object feature.

I claim:

1. A children's time signal, comprising,
a housing unit with a face plate opening,
a face plate with a decorative identifiable object thereon, the face plate covering the face plate opening,
at least one power source,
at least one time signal generator means,
a controller means,
at least one illuminating means, and
a circuit means connecting the power source to the signal generator, the controller and the illuminating means, the signal generator, controller means, illuminating means and circuit means being contained within the housing unit with the illuminating means adjacent to the face plate, the decorative identifiable object on the face plate being translucent such that light from the illuminating means can be seen through and illuminates the decorative identifiable object of the face plate, wherein the time signal generator means is set to a preset time or period of time at which time a signal would be sent to the controller means, the controller means would send a signal to the illuminating means illuminating the decorative identifiable object on the face plate.

2. The children's time signal of claim 1 wherein the face plate is a clown's face and the decorative identifiable object is a clown's nose, such that the clown's nose lights up when illuminated by the illuminating means.

3. The children's time signal of claim 1 wherein the housing unit is made of a child-safe, unbreakable material.

4. The children's time signal of claim 3 wherein the child-safe, unbreakable material is shatterproof plastic.
